(19) United States
(12) Patent Application Publication
(10) Pub. No.: US 2017/0093851 A1
(43) Pub. Date: Mar. 30, 2017

(54) BIOMETRIC AUTHENTICATION SYSTEM

(71) Applicant: Aetna Inc., Hartford, CT (US)

(72) Inventor: Douglas Allen, Cromwell, CT (US)

(21) Appl. No.: 15/187,172

(22) Filed: Jun. 20, 2016

Related U.S. Application Data
(60) Provisional application No. 62/234,961, filed on Sep. 30, 2015.

(51) Int. Cl. H04L 29/06; H04L 9/32

(52) U.S. Cl. CPC H04L 63/0861; H04L 63/0876; H04L 63/0823; H04L 9/3268; H04L 9/3231

(57) ABSTRACT

The disclosure provides a method and system for authenticating a user using biometric data and geographic location of the user's device (client device). The method involves establishing a connection between a server and a client. After the connection is established, the client device sends biometric data and location information to the server. The server then determines whether the biometric data is valid. In the event, the biometric data is valid, the server checks the location information received to determine whether the user is at a known or approved location. If the user is at an approved location, the authentication process is successful, and the server is permitted to provide data to the user according to the user's access rights.

### CROSS-REFERENCE TO RELATED APPLICATIONS

This patent application claims the benefit of U.S. Provisional Patent Application No. 62/234,961, filed Sep. 30, 2015, which is incorporated by reference in its entirety.

### BACKGROUND

Information security is extremely important to many organizations. An individual's healthcare information is particularly sensitive and must be tightly secured. In many instances, attackers find ways to overcome security hurdles in order to fraudulently obtain information residing in a remote server or database. Information obtained fraudulently may compromise an individual's privacy and may be very financially costly to society. For example, healthcare fraud accounts for roughly hundreds of billions of dollars per year. This cost is absorbed by healthcare providers, insurers, and all individuals who pay for health services. Additionally, a user's privacy is of primary importance to the healthcare industry. By securing user information, some of this fraud may be prevented since sensitive user information will not easily fall into the wrong hands. New methods and systems of safeguarding private data and enhancing data security are therefore essential.

### BRIEF SUMMARY

A user authentication method performed by a server is provided in embodiments of this disclosure. The method involves first establishing a connection with a client device, which may be a mobile phone, tablet, laptop, etc. After establishing the connection, the server receives biometric data and location information from the client device, and then determines whether the biometric data is valid or invalid. If the biometric data turns out to be valid, then the server determines whether the location information received is valid. If the location information is valid, then the user is authenticated and can perform activities according to the user's membership rights with respect to the server.

In another embodiment, the disclosure also provides a system for biometrically authenticating a user. The system includes a client device with at least one processor, at least one network interface, and memory. The client device is designed to be able to gather location information as well as obtain biometric data from a user. The system further includes at least one communication network and at least one location service that aids the client device in obtaining location information. The system further includes at least one server that receives the biometric data and the location information from the client device and determines whether the biometric data is valid. If the biometric data is valid, then the at least one server determines whether the location information is also valid. In this system, authentication is successful performed when location information is shown to be valid.

### BRIEF DESCRIPTION OF THE SEVERAL VIEWS OF THE DRAWINGS

FIG. 1 is a block diagram illustrating an exemplary networking environment or system in accordance with some example embodiments of the disclosure;

FIG. 2 is a block diagram illustrating components of a client device from the system depicted in FIG. 1 according to some example embodiments;

FIG. 3 is a block diagram illustrating components of a biometric server from the system depicted in FIG. 1 according to some example embodiments;

FIG. 4 is a flow diagram, according to certain embodiments of the disclosure, providing the steps performed by a client device to obtain information from the biometric server;

FIG. 5 is an exemplary flow diagram providing the steps performed by the biometric server to authenticate a user and provide the client device with information;

FIG. 6 is an exemplary flow diagram providing steps performed by the client device to enroll a user's biometric data at the biometric server; and

FIG. 7 is a flow diagram according to certain embodiments of the disclosure providing the steps performed by the biometric server in a biometric data enrollment process.

### DETAILED DESCRIPTION

Embodiments of the disclosure provide a method and system for an individual to be biometrically authenticated to a biometric server using a client device from a known or approved location. By successfully authenticating to the biometric server, the individual is able to access information on the biometric server within the access rights of the individual's membership profile. The client device in this case may be a mobile device like a laptop computer or a mobile phone, capable of obtaining biometric data from the individual. The client device should also be able to provide the individual's location through various location services. In some embodiments, this method eliminates the need for the individual to use a specific user identification (userID)-password combination each time he or she logs in, since the biometric data obtained by the client device will serve as a unique identifier. By also obtaining location data, individuals are further protected against fraudulent access to the biometric server. An advantage of the disclosed method and system embodiments is an added security layer to the authentication process, thereby making it much more difficult to compromise an individual's account due to a weak userID-password combination.

Embodiments of the disclosure further provide a biometric server with access to a database where the database stores information encrypted with one or more encryption algorithms that use biometric data as an encryption key. This method of storing information is advantageous over the current system that requires only a userID-password combination. In the case where a userID-password combination is compromised due to a hacker gaining access to the server, the hacker has access to personal and identifying data pertaining to the individual. In certain implementations of the biometric data encryption method, a server owner may choose to remove identifying information when storing data at the biometric server. Since biometric data is the only identifying feature that links an individual to data stored on the server, when the server is compromised, the information contained in the server will have little or no value to the hacker since the hacker will be unable to link specific individuals to data obtained. Additionally, the biometric data obtained will not be able to be linked to a specific individual by the hacker, since the hacker cannot recreate from biometric data an individual's fingerprint, retina, iris, etc.

Embodiments of the disclosure provide a method and system that is applicable to multiple avenues where data security and privacy is of great concern. The various embodiments in the disclosure may be employed in the financial industry to protect customer data on their servers, government agencies to protect information collected and stored in servers, hospitals and the medical industry to enhance the security of medical records and health information of patients, businesses to safeguard work product and protect from forms of espionage, etc.

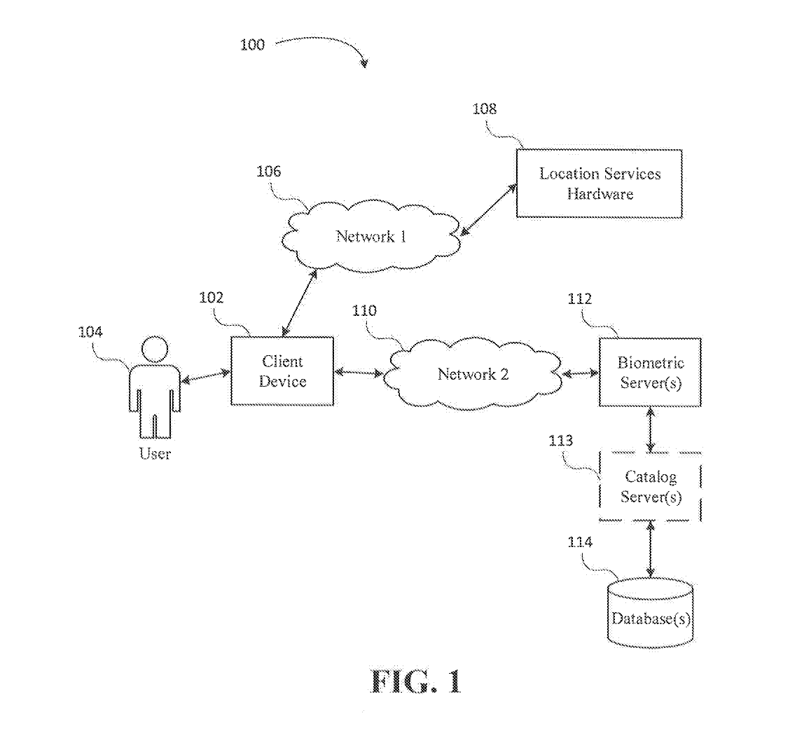

FIG. 1 is an exemplary illustration of a networking environment where some embodiments of the disclosure are applicable. The networking environment or system 100 illustrated in FIG. 1 may include a user 104 that interacts with a client device 102. The client device 102 is communicably coupled to biometric server(s) 112 and location services hardware 108 through one or more networks. The illustration in FIG. 1 shows two networks, designated as 106 and 110, but these networks may be the same network or a combination of different types of networks. FIG. 1 shows that the biometric server(s) 112 may have access to one or more databases 114. FIG. 1 provides optional servers identified as catalog server(s) 113 that serve as a conduit between the biometric server(s) 112 and the one or more databases 114. For simplicity in explanation, the singular form will be used for database 114, biometric server 112, catalog server 113, and location services hardware 108. It is understood that multiple servers may be networked to represent biometric server 112 in order to realize the functionality of the several embodiments provided in this disclosure. Additionally, multiple databases may be coupled to these multiple servers. And depending on the location services utilized, the location services hardware 108 may represent multiple devices or systems located at different physical locations.

User 104 is the individual that interacts with the client device 102. User 104 is the source of the unique biometric information. Each individual is believed to have unique biometric information, and user 104 may provide one or more unique signatures to the client device 102. These unique signatures provided by user 104 may be related to their left and/or right eye's iris, their left and/or right eye's retina, fingerprints, multi-finger fingerprints, blood samples, DNA, palm prints, facial recognition, palm veins, voice, etc. These unique signatures when represented in a format that may be digitally manipulated by a computing device are defined as unique biometric information. The biometric information, when processed with one or more algorithms and ready to be used for authentication, is referred to as biometric data. For example, user 104 scans its left iris, its right iris, and a thumbprint, and client device 102 converts each of these unique signatures to separate digital representations (biometric information). In some embodiments, an algorithm is applied to combine the three separate digital representations into a unified representation which is referred to here as biometric data. In some embodiments, the separate digital representations are not combined but are formatted to represent separate biometric data with one being a primary biometric data and the others being secondary. For example, the thumbprint may be the primary biometric data, but for redundancy, in case the individual has a recent scratch or cut on its thumb, the left iris may be used to verify when the thumbprint fails. To preserve gender neutrality, where applicable, “it” and “its” are the subject and possessive pronouns associated with user 104 or individual throughout this document.

User 104 is the source of the unique biometric signatures which are converted to biometric information by the client device 102. When the biometric information is used to interact with the outside world, the biometric information is termed biometric data. This is the case because client device 102 may perform certain formatting steps, including feature extraction, compression, etc., to prepare the biometric information for use.

Client device 102 is a computing device with certain capabilities. Client device 102 may be a desktop computer, a tablet computer, a laptop computer, a mobile phone, a smartphone, a video game system, a smart watch, a smart television, a personal digital assistant (PDA), a wearable or embedded digital device, etc. In some embodiments, client device 102 supports multiple types of networks. For example, the client device 102 may have Ethernet connectivity, Wi-Fi connectivity, and cellular or mobile network connectivity supporting different technologies, such as, Global System for Mobile Communications (GSM) standard.

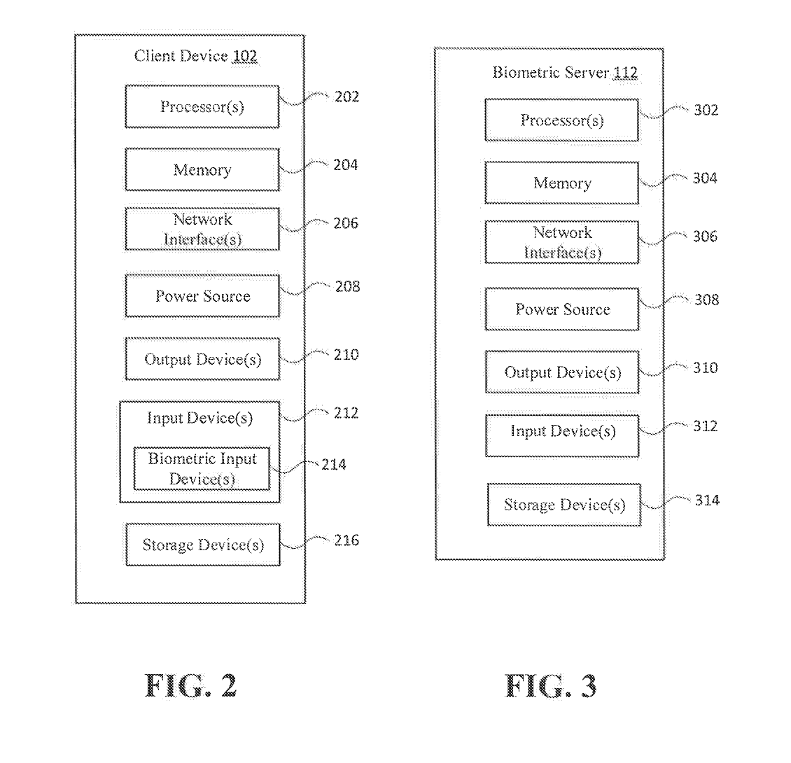

FIG. 2 illustrates a block diagram of the basic hardware components for the client device 102 according to some aspects of the disclosure. The client device 102 may include one or more processors 202, memory 204, network interfaces 206, power source 208, output devices 210, input devices 212, biometric input devices 214, and storage devices 216. Although not explicitly shown in FIG. 2, each component provided is interconnected physically, communicatively, and/or operatively for inter-component communications in order to realize functionality ascribed to the client device 102. To simplify the discussion, the singular form will be used for all components identified in FIG. 2 when appropriate, but the use of the singular does not limit the discussion to only one of each component. For example, multiple processors may implement functionality attributed to processor 202.

Processor 202 is configured to implement functions and/or process instructions for execution within client device 102. For example, processor 202 executes instructions stored in memory 204 or instructions stored on a storage device 216. In certain embodiments, instructions stored on storage device 216 are transferred to memory 204 for execution at processor 202. Memory 204, which may be a non-transient, computer-readable storage medium, is configured to store information within client device 102 during operation. In some embodiments, memory 204 includes a temporary memory that does not retain information stored when the client device 102 is turned off. Examples of such temporary memory include volatile memories such as random access memories (RAM), dynamic random access memories (DRAM), and static random access memories (SRAM). Memory 204 also maintains program instructions for execution by the processor 202 and serves as a conduit for other storage devices (internal or external) coupled to client device 102 to gain access to processor 202.

Storage device 216 includes one or more non-transient computer-readable storage media. Storage device 216 is provided to store larger amounts of information than memory 204, and in some instances, configured for long-term storage of information. In some embodiments, the storage device 216 includes non-volatile storage elements. Non-limiting examples of non-volatile storage elements include floppy discs, flash memories, magnetic hard discs, optical discs, solid state drives, or forms of electrically programmable memories (EPROM) or electrically erasable and programmable (EEPROM) memories.

Network interfaces 206 are used to communicate with external devices and/or servers. The client device 102 may comprise multiple network interfaces 206 to facilitate communication via multiple types of networks. Network interfaces 206 may comprise network interface cards, such as Ethernet cards, optical transceivers, radio frequency transceivers, or any other type of device that can send and receive information. Non-limiting examples of network interfaces 206 include radios compatible with several Wi-Fi standards, 3G, 4G, Long-Term Evolution (LTE), Bluetooth®, etc.

Power source 208 provides power to client device 102. For example, client device 102 may be battery powered through rechargeable or non-rechargeable batteries utilizing nickel-cadmium or other suitable material. Power source 208 may include a regulator for regulating power from the power grid in the case of a device plugged into a wall outlet, and in some devices, power source 208 may utilize energy scavenging of ubiquitous radio frequency (RF) signals to provide power to client device 102.

Client device 102 may also be equipped with one or more output devices 210. Output device 210 is configured to provide output to a user using tactile, audio, and/or video information. Examples of output device 210 may include a display screen (cathode ray tube (CRT) display, liquid crystal display (LCD) display, LCD/light emitting diode (LED) display, organic LED display, etc.), a sound card, a video graphics adapter card, speakers, magnetics, or any other type of device that may generate an output intelligible to user 104.

Client device 102 is equipped with one or more input devices 212. Input devices 212 are configured to receive input from user 104 or the environment where client device 102 resides. In certain instances, input devices 212 include devices that provide interaction with the environment through tactile, audio, and/or video feedback. These may include a presence-sensitive screen or a touch-sensitive screen, a mouse, a keyboard, a video camera, microphone, a voice responsive system, or any other type of input device.

A subset of input devices 212 necessary for implementation of the method and system provided in this disclosure includes biometric input devices 214. One or more biometric input devices 214 are provided in client device 102 in order to facilitate the collecting of biometric information from user 104. Biometric input devices 214 may include near infrared cameras to facilitate iris scans; cameras for facial recognition; fingerprint sensors of different technologies including ultrasonic sensors, active and passive capacitive sensors, and optical sensors like charge-coupled devices (CCDs); and other scanners, cameras, and imaging technologies to obtain palm prints, palm veins, etc.

The hardware components described thus far for client device 102 are functionally and communicatively coupled to achieve certain behaviors. In some embodiments, these behaviors are controlled by software running on an operating system of client device 102. In addition to client device 102, FIG. 1 also includes location services hardware 108, biometric server 112, database 114, and in some embodiments catalog server 113. Database 114 is one or more servers that specialize in storage of information for quick access. In certain aspects of the disclosure, database 114 is organized in a manner where information stored is encrypted with one or more encryption algorithms. The optional catalog server 113 specializes in obtaining information from database 114 and providing a further separation between authentication servers and database information, thereby disallowing direct access of commands of client device 102 to database 114. In certain embodiments, catalog server 113 serves to separate authentication servers (biometric server 112) from the information retrieval from one or more databases 114.

In FIG. 3, a block diagram of biometric server 112 is provided with exemplary components. The behavior, function, and description of the various components are analogous to those already described for client device 102. For example, biometric server 112 may include one or more processors 302, memory 304, network interfaces 306, power source 308, output devices 310, input devices 312, and storage devices 314. The description for these components will not be provided, but it is understood that examples may include those already provided for client device 102. Catalog server 113 may contain similar components to that of biometric server 112.

Location services hardware 108 are external services and hardware that facilitate the determination of the location of client device 102. For example, in the case client device 102 is equipped with a Global Positioning System (GPS) transceiver or receiver, location services hardware 108 would comprise GPS satellites that communicate GPS location information to the client device 102. Client device 102 may then combine the GPS location information with a mapping service to determine an address associated with the GPS coordinates obtained. In some embodiments, client device 102 determines location information through cellular network, so location services hardware 108 comprises a cellular provider's network infrastructure. The cellular provider may locate client device 102 in multiple ways—by identifying the cell tower servicing client device 102, by using multiple cell towers and triangulating to provide a location of client device 102, by using multiple cell towers and applying forward link or trilateration to provide a location of client device, by using cell towers to measure radio signal strength and communication delays to subscriber identity module (SIM) card on client device 102, etc. In some embodiments, client device 102 determines location information through Wi-Fi Positioning Systems (WiPS). In these instances, the Service Set Identifier (SSID) and media access control (MAC) address of one or more access points are used with the relative signal strength received at client device 102 from the one or more access points to calculate location of client device 102. In certain instances, client device 102 uses a hybrid system that employs a combination of multiple location determination methods. For example, by using GPS in addition to cellular network tracking, location services hardware 108 would comprise a cellular provider's network infrastructure as well as GPS infrastructure.

The system 100 in FIG. 1 is therefore adaptable to accommodate various embodiments. For example, when determining location of client device 102 with hybrid location determination, then network 1, identified as item 106, comprises multiple communication networks, and client device 102 possesses the hardware to facilitate communication on these different communication networks. Since the catalog server 113 is optional and is only provided in certain embodiments, for clarity of explanation, the following discussion will describe embodiments where the biometric server 112 has direct access to database 114.

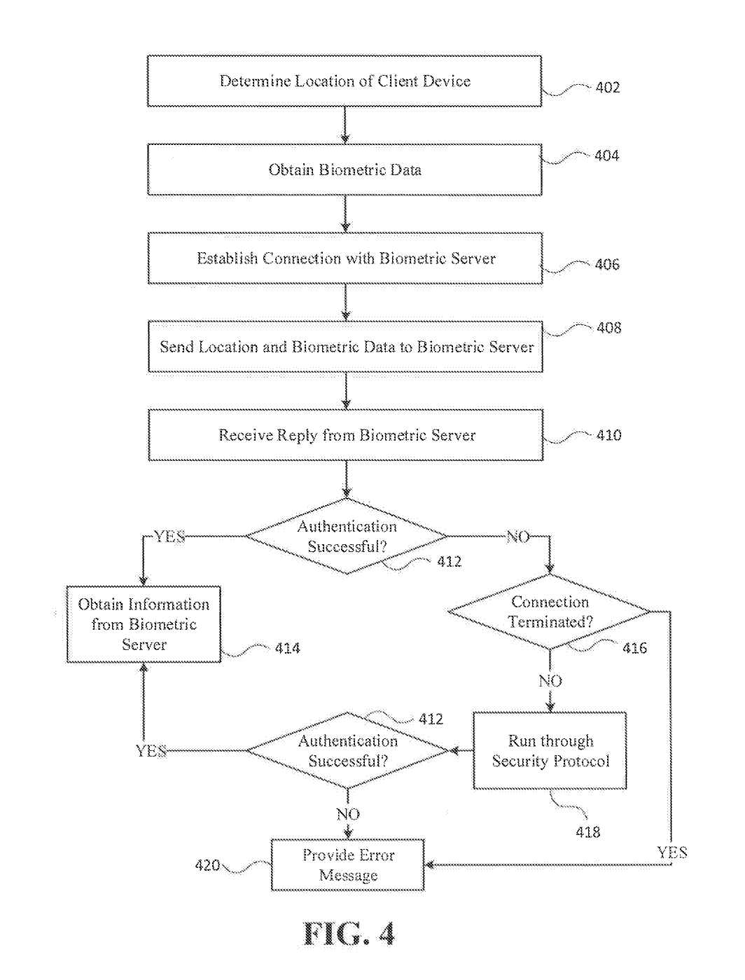

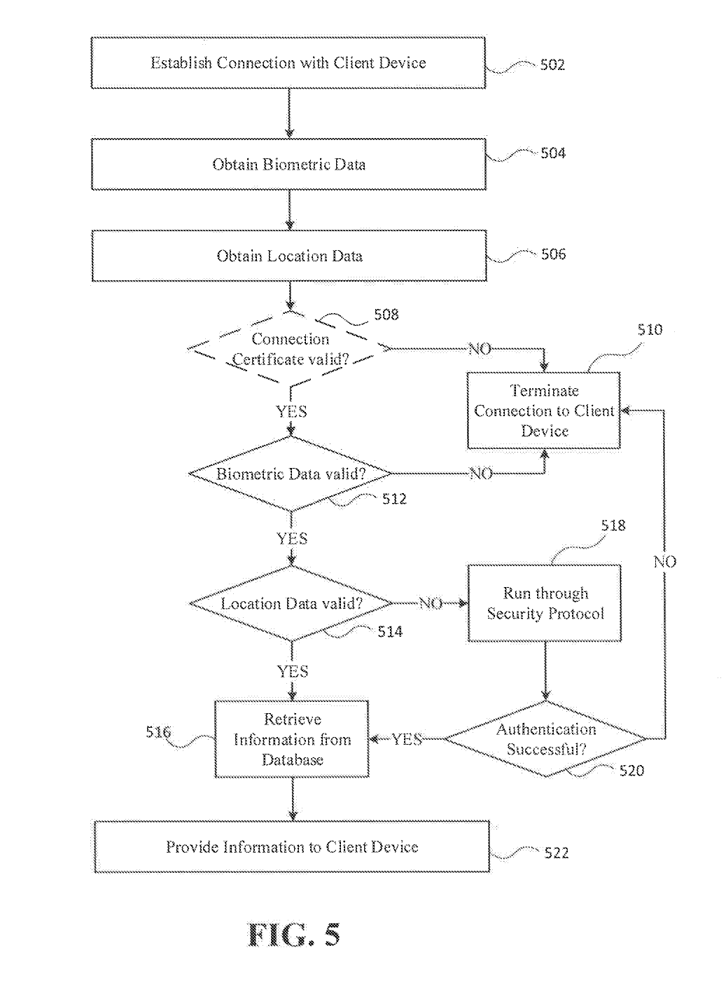

FIG. 4 is a flow diagram, according to certain embodiments of the disclosure, providing the steps performed by client device 102 to obtain information from the biometric server 112. The user 104 of the client device 102 needs to be authenticated to biometric server 112, and after the authentication process, the information requested by the user 104 will be provided to client device 102 by the biometric server 112. The following paragraphs provide detailed narrative of the steps involved in this process.

At step 402, the client device 102 determines its location using one or more of the various methods already discussed. The location information may be stored in multiple ways. For example, instead of purely longitude-latitude coordinates, the location information may have a mailing or physical address associated with it. In some instances, the location information may utilize platforms like GeoPlanet with a WOEID (Where On Earth Identifier) or a NAC locator.

At step 404, the client device 102 obtains biometric data using one of the methods already described above. In an exemplary embodiment, the user 104 looks into the camera of a mobile device (client device 102) to scan its left iris and then its right iris. The client device 102 then converts the scans to a biometric vector which serves as the biometric data that will be used for authentication. In some embodiments, the biometric vector may have a minimum of 512 character string of numbers and letters.

At step 406, the client device 102 establishes a connection with the biometric server 112. In some embodiments, this involves locating an internet address of the biometric server 112 and requesting a security certificate from the biometric server 112. Client device 102 requests the security certificate in order to have biometric server 112 identify itself. The security certificate may be a Secure Sockets Layer (SSL) certificate or a Transport Layer Security (TLS) certificate. The security certificate may support one of RSA algorithm, Digital Signature Algorithm (DSA), and Elliptic Curve Cryptography (ECC) algorithm. After the security certificate request, the biometric server 112 then provides a security certificate to the client device 102, and the client device 102 determines whether or not to trust the certificate. After the client device 102 acknowledges that it trusts the certificate, then biometric server 112 sends a digitally signed acknowledgement to start an encrypted session based on the security certificate type with the client device 102. In certain embodiments, the client device 102 provides a security certificate or client certificate to the biometric server 112. This way, biometric server 112 is assured that client device 102 is an approved device.

After a secure connection is established between the client device 102 and the biometric server 112, at step 408, the client device 102 proceeds to send location data (step 402) and biometric data (step 404) to the biometric server 112.

At step 410, the client device 102 receives a reply from the biometric server 112. The reply may take multiple forms. For example, the biometric server 112 may find that the biometric data provided is not valid and may provide an error message to the client device 102. The biometric server 112 may find that the location data is not valid and may provide an error message to the client device 102. The biometric server 112 may further find that the obtained information (the location and the biometric data) provided by the client device 102 is valid and provide a message or acknowledgement to the client device 102 that authentication is successfully performed.

At step 412, the client device 102 determines, through the reply received from the biometric server 410, whether the authentication was successful. If the authentication is successfully performed, the client device 102 proceeds to step 414 and obtains information from the biometric server 112. The information obtained from the biometric server 112 is limited to the security clearance or security access of the profile that user 104 has with the owner of the biometric server 112.

At step 412, if authentication is unsuccessful, the client device 102 may proceed to step 416 to determine whether connection to the biometric server 112 has been terminated. In the case where the connection to the biometric server has been terminated, an error message is provided at step 420. For example, this safeguard may be put in place when biometric data does not match, and the biometric server 112 unilaterally terminates connection to the client device 102. At step 416, if the connection is still open then the client device 102 receives one or more security queries at step 418. In certain embodiments, this safeguard is put in place when location data does not match, but biometric data matches. The security protocol may involve answering one or more security questions related to the user profile, the individual, and verifying CAPTCHAs (Completely Automated Public Turing test to tell Computers and Humans Apart). After the series of security tests, the client device 102 will determine again at step 412 whether or not authentication is successful. In the event authentication is successful, the client device proceeds to step 414, and if not successful, step 420.

FIG. 5 is an exemplary flow diagram providing the steps performed by the biometric server 112 to authenticate a user and provide the client device 102 with information. FIG. 5 is analogous to FIG. 4 and is provided from the perspective of the biometric server 112. At step 502, the biometric server 112 establishes a connection with the client device. This step may involve security certificates as explained earlier. The biometric server 112 may provide a security certificate to the client device 102 or receive a security certificate from the client device 102.

After establishing a connection with the client device 102, at steps 504 and 506, the biometric server 112 obtains biometric data and location data, respectively. After obtaining the biometric and location data from the client device 102, in certain instances, the biometric server 112 may check, at step 508, whether the security certificate received from the client device 102 is valid in light of the data obtained. For example, after obtaining location data of the client device 102 and determining that the client device 102 is in Norway, but security certificate from client device 102 identifies a device registered in the United States, a financial institution may revoke the security certificate as a cautionary measure and terminate connection to the client device 102 at step 510.

After successfully passing through step 508, at step 512, biometric server 112 determines whether or not the biometric data obtained from the client device 102 is valid. If the biometric data is not valid, then the connection to the client device is terminated at step 510. If the biometric data is valid, then the biometric server 112 determines at step 514 whether the location data is valid.

In certain embodiments of the disclosure, step 514 requires comparing different sets of locations. Locations may be either known locations associated with an individual's profile or approved locations associated with the owner of the biometric server 112. For example, in the healthcare system, when attempting to access health records from an insurance company's server, an approved location may be one of many care providers in the insurer's network. Approved locations may include addresses or longitude-latitude coordinates of doctor's offices, clinics, pharmacies, hospitals, etc. Known locations in this example would be the user's home, work, an out of network care provider, or any other place that the user has added to its profile. At step 514, the biometric server 112 retrieves a set of known locations and a set of approved locations and compares location data received from the client device 102 against these sets of locations. The biometric server 112 determines if a location is valid within a margin of error. For example, the location may be considered valid within 500 feet of the exact known location. In other examples, a building's square footage is taken into consideration to adjust the margin of error if the biometric server 112 has such information.

If location data is valid, at step 516, the biometric server 112 retrieves information from the database 114 for the client device 102. For example, information retrieved may be medical records, financial statements, business work product, trade secrets, contracts, journals, etc. In certain embodiments, the information on the database 114 is encrypted with encryption key related to biometric data obtained by the client device 102. At step 522, the information retrieved is provided to client device 102 through the secure connection established at step 502.

In the event the location data is not valid at step 514, the biometric server 112 presents a security protocol to client device 102 at step 518. After receiving the answers to the security questions or the feedback from the client device 102 regarding the security protocol, the biometric server 112 determines at step 520 whether authentication is successful. At this point, if authentication is successful, then the biometric server 112 may add the new location or prompt the user to add the new location to known locations associated with the user's profile and then proceed to step 516. If the authentication is unsuccessful, then the biometric server 112 may terminate connection to the client device 102.

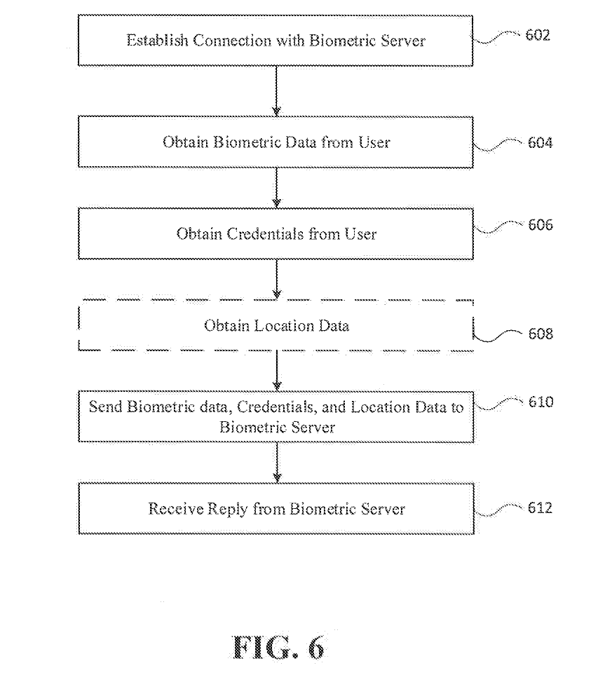

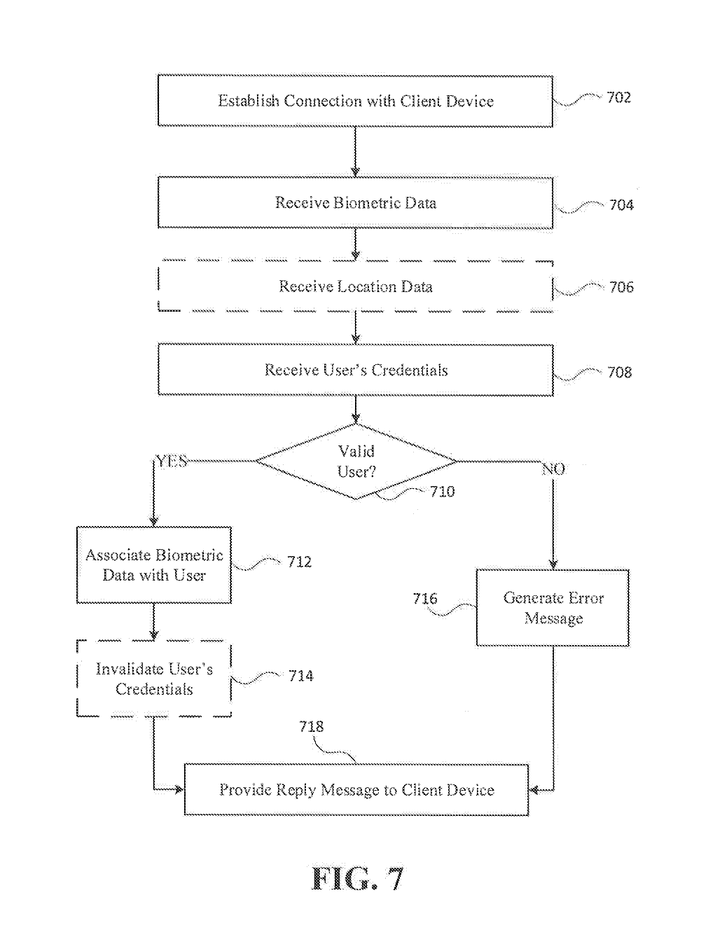

The previous discussion surrounding FIG. 4 and FIG. 5 provided exemplary embodiments of how to access information on the database 114 through the biometric server 112. The user profile tied to biometric data in these embodiments was either available (successfully authenticated) or unavailable (unsuccessful authentication) to the server. FIG. 6 and FIG. 7 will provide examples relating to the enrollment process of the biometric data used for authenticating the user at the biometric server 112.

FIG. 6 is an exemplary flow diagram providing steps performed by the client device 102 to enroll biometric data at the biometric server 112. At step 602, the client device 102 establishes a connection with the biometric server 112. At step 604, the client device 102 obtains biometric data from the user 104. At step 606, the client device obtains credential information from the user 104. Credential information may include a userID-password combination to authenticate to a member profile already in existence on biometric server 112. In other embodiments, the user 104 is creating a new profile, and credentials may be identifying information about the user 104 to verify that the user 104 is authorized to create a profile on the biometric server 112.

At step 608, the client device 102 may determine location data. In certain instances, this step is optional because the user 104 may only be enrolling their biometric data and not have a known location on profile. In other instances, the user 104 may only enroll biometric data at approved locations and location information is necessary in order to enroll biometric data. In other instances, since the member profile does not exist, location data does not exist, and the user 104 has an option of providing a known location at the time of setting up their member profile, so client device 102 automatically obtains location information.

At step 610, the client device 102 sends the biometric data, credential information, and location data to the biometric server 112. At step 612, the client device 102 receives a reply from the biometric server 112. The reply may be a successful enrollment of biometric data, or it may be an error. In some embodiments, several steps follow this process if an error occurs. For example, the user 104 may be prompted to enter credentials pertaining to userID and password if the combination previously entered was not found. The user 104 may also be required to go through a security protocol before the biometric data is accepted in order to verify the identity of the user 104. These additional or contingency steps beyond step 612 occur when further information is necessary or when the reply provided at step 612 is an error.

FIG. 7 is a flow diagram according to certain embodiments of the disclosure providing the steps performed by the biometric server 112 to enroll a user's biometric data. At step 702, the biometric server 112 establishes a connection with the client device 102. At steps 704 and 706, the biometric server 112 receives biometric data and location data, respectively. As discussed for step 608, location data may be optional in the enrollment process. At step 708, the biometric server 112 receives a user's credentials, and at step 710, determines whether the user exists. The user's credentials are used to determine whether or not the user is a valid user.

If the user is not a valid user, then an error message is generated at step 716 and provided to the client device 102 at step 718. If the user is a valid user, then the biometric server 112 proceeds, at step 712, to associate the received biometric data with the valid user or member profile. Once the biometric data is accepted, in some embodiments, the user's credentials used for authentication are invalidated at step 714. This step is performed in order to secure information related to the user or member in the database 114. While invalidating the user's credentials, in some embodiments, the user's information stored in the database 114 is encrypted with the newly obtained biometric data. At step 718, a reply message is provided to the client device.

The discussion thus far has focused on the method and system of authenticating. Certain embodiments, especially embodiments related to mobile device implementation of the client device 112 able to perform iris scans, provide additional features that may not have been captured in the earlier discussion. In a mobile environment, some embodiments of the disclosure may use any mobile operating system with any camera that has near infrared functionality to be able to scan a live iris. Existing iris scans currently use a near infrared camera. The near infrared camera may be a peripheral device on the mobile device attached to one of the mobile device's interfaces or external connectors. The mobile application running on the mobile device would conceivably request the user to press the screen to start the authentication process by looking into the front-facing near infrared camera. The application would then scan the iris of the eyes and reply back to the user when the scan has been completed. The message back to the user would be one of successful verification, unsuccessful verification with option to add new individual, unsuccessful verification due to unknown location with option to contact customer service to add location, etc. Mainly, the user's interaction with the mobile device will be by pressing tabs or buttons on the screen or using voice commands to navigate the mobile application. Initial user interaction may require the user to “start” authentication by pressing one or more buttons on the mobile device's screen to start the process.

Initial authentication is accomplished by opening the mobile application and following prompts to authenticate. If not authenticated, the user will have the option to enroll and follow those prompts accordingly. The user will look into the near infrared camera, and the mobile application will translate picture of the iris of each eye into a biometric vector. The mobile application will obtain a security certificate from a biometric server via existing secure communication. The mobile application will send biometric vector and location of mobile device (geo-location) to the biometric server. In certain embodiments, initial enrollment will require user to enter their member credentials so that existing records can now be updated via one or more server processes to replace member credentials with the new biometric vector and known geo-location.

After initial enrollment, in some embodiments, the user would then authenticate and have an option to add new location. The mobile device that the user uses to authenticate is not required to be the same as the one that the user initially enrolled on. The user may request to have their new location added to known locations by pressing one or more buttons on the mobile device's screen. This will cause the application to send a message to the biometric server requesting that the new location be added. The biometric server will detect the new message by the mobile application. In certain embodiments, the biometric server is connected to a customer service center, and the request to add a new location causes the biometric server to send a message to the customer service center. A customer service agent will then call the user to verify that the user is in fact requesting the new location to be added. In certain instances, this call may be automated or may be provided through a series of screen prompts on the mobile device. This multiple-step security protocol ensures that the user is able to verify that the request is not made under duress. If the user successfully clears the security protocol, then the user's new location will be added as a known location.

The various embodiments provided in the disclosure may be applicable in several situations. For example, in addition to state issued identification, healthcare providers or financial institutions may use this system to verify the identity of whom they believe they are dealing with before divulging sensitive material. For example, an individual may go to a doctor's office seeking medical attention. To verify their identity, obtain medical records, insurance plan information, and other health related data, the individual may use a client device at the doctor's office to interact with an insurer's remote biometric server. This system also ensures that employees at a health care provider's place of employment need to have the patient present in order to access sensitive medical information related to the patient. This method further reduces medical fraud, since the health care provider will have a higher level of certainty of the individual's or patient's identity.

Additionally, in the medical care environment, the patient's health insurance information is secure and safe even if hacked, as biometric vector or biometric data cannot be used to re-create an individual's unique signature.

By incorporating location information, the biometric server is able to detect and confirm that the location of request to authenticate is at a known location or a recognized medical facility. This verifies that an individual's authentication is being performed for a valid reason. In the medical setting, people with chronic illnesses, especially children, are no longer required to carry medical alert ID's that can get lost or broken. Additionally, when the individual travels, the individual's medical information is available anywhere in the world where there is cell phone service.

In some embodiments, an equally important advantage is that since biometric data is necessary for authentication, the individual is oblivious to the exact nature or contents of the biometric data. The biometric data or biometric vector is obtained from an algorithm that may be updated over time in order to enhance security. The user or individual no longer needs to remember to change passwords because this process is now automatically done by the owners of the biometric server when the biometric vector or biometric data algorithm is changed. The new algorithm may be pushed to the client devices. In some embodiments, when the algorithm changes, the owners may reverse engineer the old biometric data to obtain new biometric data, so the user or individual is oblivious to the change in algorithm. In other embodiments, when the algorithm changes, the client device provides two different biometric data to the biometric server. The first biometric data is based on the old algorithm in order to find and associate the user with the correct profile in the database. After retrieving the profile in the database, the second biometric data is then used to replace the first biometric data in the database, and then the first biometric data is invalidated. This process again is transparent to the user. An owner of the biometric server may choose to perform security updates from time to time on select or all individual profiles in order to keep the database secure.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method to authenticate a user, the method performed by a biometric server with at least one processor, memory, and non-transitory computer readable storage medium, the method comprising:
connecting, by the biometric server, to a client device;
receiving, by the biometric server, biometric data and location information from the client device;
determining, by the biometric server, whether biometric data is valid; and
in response to said determining that biometric data is valid, determining, by the biometric server, whether location information is valid.

2. The method of claim 1, further comprising:
obtaining, by the biometric server, a security certificate from the client device;
determining, by the biometric server, whether the security certificate is valid; and
in response to said determining, when the security certificate is not valid, terminating, by the biometric server, the connection to the client device.

3. The method of claim 2, wherein the security certificate is at least one of a Secure Sockets Layer (SSL) certificate and a Transport Layer Security (TLS) certificate.

4. The method of claim 3, wherein the security certificate supports one algorithm selected from the group consisting of: RSA algorithm, Digital Signature Algorithm (DSA), and Elliptic Curve Cryptography (ECC) algorithm.

5. The method of claim 1, further comprising:
conditionally retrieving, by the biometric server, information from a database when location information is valid; and
providing, by the biometric server, the information retrieved to the client device.

6. The method of claim 5, wherein the information retrieved is encrypted and the biometric data contains the decryption key.

7. The method of claim 1, further comprising:
conditionally performing, by the biometric server, a security protocol when location information is invalid, wherein the security protocol comprises requesting additional information from the client device.

8. The method of claim 7, wherein the additional information comprises an identification number and a security question.

9. The method of claim 1, wherein the biometric data comprises data obtained from at least one of an iris scan, a retinal scan, fingerprint, blood sample, DNA, palm print, facial recognition, palm veins.

10. The method of claim 1, wherein the location data comprises data derived from at least one of Global Positioning Systems (GPS), cellular tower triangulation, Subscriber Identity Module (SIM), Wi-Fi Positioning Systems.

11. The method of claim 1, wherein the determining whether location information is valid comprises:
retrieving, by the biometric server, from a database a set of known locations associated with the user;
retrieving, by the biometric server, from the database a set of approved locations;
comparing, by the biometric server, the location information to the set of known locations and the set of approved locations; and
determining whether the location information is contained at least one of the set of known locations and the set of approved locations.

12. A system for biometrically authenticating a user, the system comprising:
a client device comprising at least one processor, at least one network interface, and memory, the client device configured to obtain location information and biometric data;
at least one communication network;
at least one location service, the at least one location service configured to assist the client device in obtaining location information; and
at least one server, configured to:
receive the biometric data and the location information from the client device,
determine whether the biometric data is valid, and
conditionally determine whether the location information is valid when the biometric data is valid;
wherein the client device, the at least one location service, and the at least one server are communicably coupled through the at least one communication network.

13. The system of claim 12, wherein the at least one server is further configured to:
obtain a security certificate from the client device;
determine whether the security certificate is valid; and
conditionally terminate the connection to the client device when the security certificate is not valid.

14. The system of claim 13, wherein the security certificate is at least one of a Secure Sockets Layer (SSL) certificate and a Transport Layer Security (TLS) certificate.

15. The system of claim 12, further comprising:
at least one database, wherein the at least one server is further configured to:
conditionally retrieve information from the at least one database when location information is valid, and
provide the information retrieved to the client device.

16. The system of claim 15, wherein data in the at least one database is encrypted and the biometric data contains the key to decrypt the information retrieved.

17. The system of claim 12, wherein the at least one server is further configured to:
conditionally perform a security protocol when the location information is invalid, wherein the security protocol comprises requesting additional information from the client device.

18. The system of claim 12, wherein the client device further comprises at least one of a near infrared camera, a camera, a fingerprint sensor, an ultrasonic sensor, a capacitive sensor, and an optical sensor.

19. The system of claim 12, wherein the client device further comprises at least one of a Global Positioning Systems (GPS) receiver, a Wi-Fi network interface, a cellular network interface, and a Subscriber Identity Module (SIM) card.

20. A non-transitory computer readable medium for authenticating a user, the non-transitory computer readable medium having computer executable instructions for performing the steps of:
connecting a biometric server to a client device;
receiving, at the biometric server, biometric data and location information sent by the client device;
determining, at the biometric server, whether the biometric data is valid; and
in response to said determining that biometric data is valid, determining, at the biometric server, whether the location information is valid.
